(19) United States
(12) Patent Application Publication
(10) Pub. No.: US 2013/0107897 A1
(43) Pub. Date: May 2, 2013

(54) METHOD FOR TRANSMITTING AN ESMC MESSAGE THROUGH A SONET/SDH DOMAIN

(71) Applicants: Dinh Thai Bui, Nozay (FR); Michel Le Pallec, Nozay (FR)

(72) Inventors: Dinh Thai Bui, Nozay (FR); Michel Le Pallec, Nozay (FR)

(21) Appl. No.: 13/806,018

(22) PCT Filed: Jun. 30, 2011
(86) PCT No.: PCT/EP2011/061025

§ 371 Date: Jan. 17, 2013

(30) Foreign Application Priority Data
Jun. 30, 2010 (FR) 1002753

(51) Int. Cl. H04L 7/00

(52) U.S. Cl. CPC H04L 7/0008
USPC 370/503

(57) ABSTRACT

The embodiments of the present invention describe a method for transmitting an Ethernet Synchronization Messaging Channel “ESMC” message between a first and a second Synchronous Ethernet “SyncE” domain, said first and second domains being interconnected by a third, Synchronous Optical Networking/Synchronous Digital Hierarchy “SONET/SDH” domain, in which at least one part of said Ethernet Synchronization Messaging Channel “ESMC” message is encapsulated when entering said third domain and unencapsulated when exiting said third domain, so as to create a network tunnel through the Synchronous Optical Networking/Synchronous Digital Hierarchy “SONET/SDH” domain.

The present invention pertains to the domain of communication networks, and more particularly the transmission of information carried by Ethernet Synchronization Messaging Channel (ESMC) messages through Synchronous Optical Networking/Synchronous Digital Hierarchy (SONET/SDH) domains.

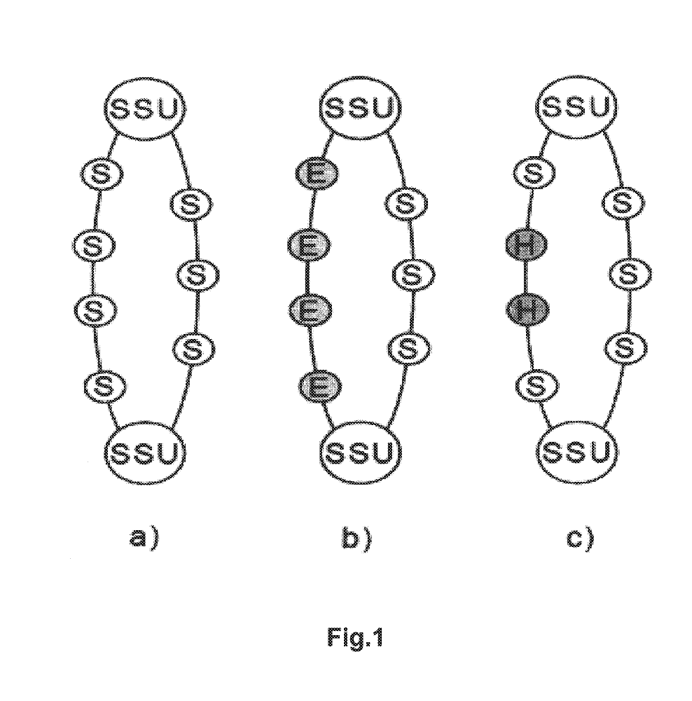

This is because the SDH/SONET and Synchronous Ethernet (SyncE) domains are compatible from the standpoint of physically distributing a Synchronization frequency as depicted in FIG. 1, in which SyncE nodes E (FIG. 1 b) or hybrid nodes H, meaning those that have both SDH/SONET and SyncE interfaces, (FIG. 1 c) are inserted into an existing synchronization chain comprising SDH/SONET nodes S and synchronization units (Synchronization Supply Units) SSU, the distribution of the synchronization signal being carried out by the physical layer in all of those domains.

In SONET/SDH domains, the synchronization signal's quality level (or QL) is carried within the physical layer, in the header of SONET/SDH frames.

In SyncE domains, meanwhile, the synchronization status is carried by ESMC messages (or packets) that contain Type Length Value (TLV) structures as specified in the 802.3 protocol by the Institute of Electrical and Electronic Engineers (IEEE 802.3)). At present, only one of these TLV structures is standardised by the International Telecommunications Union (ITU-T). This is the TLV field indicating the synchronization signal's quality level (ordinarily designated by QL-TLV) in order to maintain compatibility with SONET/SDH.

Proposals to add TLV structures have, however, been made within UIT-T in order to optimise the use of those ESMC messages. These additional TLVs make it possible to carry other information that is helpful for managing synchronization.

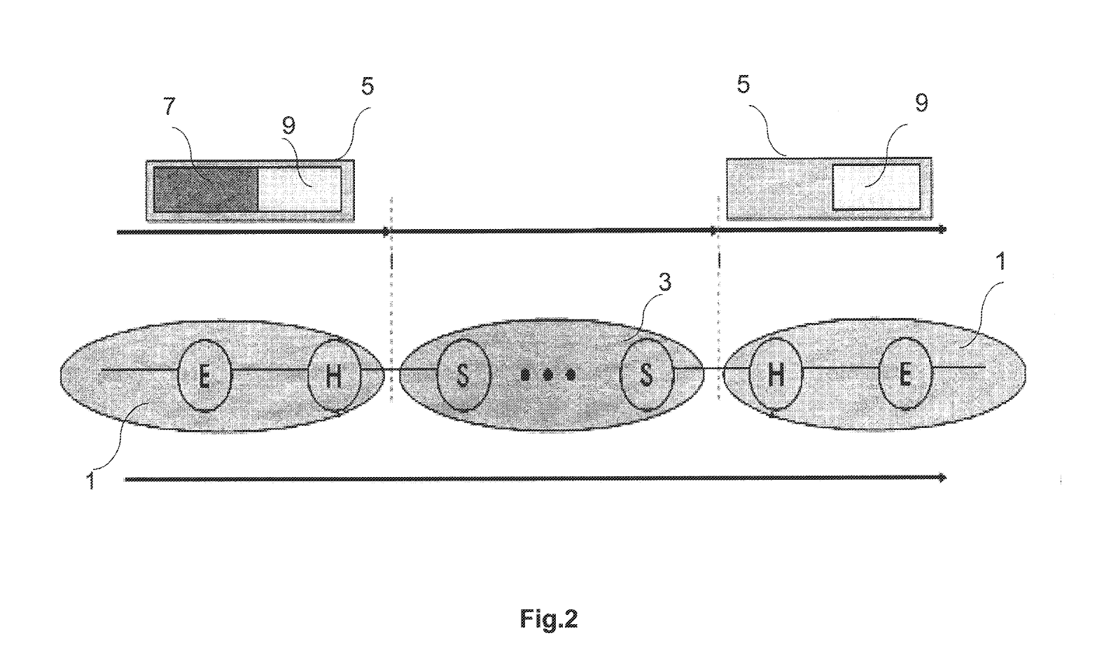

In the configuration described in FIG. 2 in which two SyncE domains 1 are interconnected by one SONET/SDH domain 3, the additional TLV structures 7, if any (meaning those besides the QL-TLV structure 9) are filtered within the SyncE-SONET/SDH interface. This is because this information is not defined in the SONET/SDH header, and there is no longer any way to extend the format of those headers without deeply impacting (i.e. hardware changes) the large amount of SONET/SDH equipment already deployed on the premises.

The need is therefore to propose a method that would make it possible to transmit data related to additional TLV structures with respect to QL-TLV 9 through SDH/SONET domains 3.

Thus, the present invention pertains to a method for transmitting an Ethernet Synchronization Messaging Channel “ESMC” message between a first and a second Synchronous Ethernet “SyncE” domain, said first and second domains being interconnected by a third, Synchronous Optical Networking or Synchronous Digital Hierarchy “SONET/SDH” domain, in which at least one part of said Ethernet Synchronization Messaging Channel “ESMC” message is encapsulated when entering said third domain and unencapsulated when exiting said third domain, so as to create a network tunnel through that third Synchronous Optical Networking/Synchronous Digital Hierarchy “SONET/SDH” domain.

According to another aspect of the present invention, said method comprises at least one Type Length Value “TLV” field different from the Quality Level “QL-TLV” field.

According to an additional aspect of the present invention, the encapsulation and unencapsulation of the messages is done in the Synchronous Ethernet-Synchronous Optical Networking/Synchronous Digital Hierarchy “SyncE-SDH/SONET” hybrid nodes located at the interface of the various domains.

According to an additional aspect of the present invention, a Synchronous Ethernet-Synchronous Optical Networking/Synchronous Digital Hierarchy “SyncE-SDH/SONET” hybrid node receives

firstly, at least two distinct synchronization signals that have taken different routes and that come from different source border hybrid nodes, and,
secondly, at least two different Ethernet Synchronization Messaging Channel “ESMC” messages corresponding to said at least two synchronization signals, and coming from different tunnels,
wherein said at least two messages comprising an additional Type Length Value “TLV” field that makes it possible to tell different Ethernet Synchronization Messaging Channel “ESMC” messages apart.

According to another aspect of the present invention, a Synchronous Optical Networking/Synchronous Digital Hierarchy “SONET/SDH” node receives at least two different synchronization signals that have taken different routes and that come from different source border hybrid nodes,

selects the primary synchronization signal to distribute, based on a list of priorities provided by a synchronization management system.
and wherein, in the event that the primary synchronization signal degrades and the primary synchronization signal is reselected, a message, comprising an identification of the new selected primary synchronization signal, is transmitted to the synchronization management system. Said synchronization management system then transmitting, to the destination Synchronous Ethernet-Synchronous Optical Networking/Synchronous Digital Hierarchy “SyncE-SONET/SDH” hybrid node, an identification of the synchronization source corresponding to the selected synchronization signal in order to allow the destination border hybrid node to consider the tunnel encapsulating the Ethernet Synchronization Messaging Channel “ESMC” message associated with the selected primary synchronization signal.

According to an additional aspect of the present invention, the additional, at least one, Type Length Value “TLV” field indicates the stability level of the frequency provided by the frequency source.

According to an additional aspect of the present invention, at least one additional Type Length Value “TLV” field indicates the number of nodes traversed by said message since its source node.

According to an additional aspect of the present invention, the additional, at least one, Type Length Value “TLV” field comprises an identification of the nodes traversed by said message.

According to an additional aspect of the present invention, the tunnel associated with the Ethernet Synchronization Messaging Channel “ESMC” message of the Synchronous Optical Networking/Synchronous Digital Hierarchy “SONET/SDH” domain follows the same route as the synchronization signal.

According to an additional aspect of the present invention, the tunnel associated with the Ethernet Synchronization Messaging Channel “ESMC” message of the Synchronous Optical Networking/Synchronous Digital Hierarchy “SONET/SDH” domain follows a different route from the synchronization signal.

The present invention also pertains to a Synchronous Ethernet-Synchronous Optical Networking/Synchronous Digital Hierarchy “SyncE-SDH/SONET” hybrid node comprising means for encapsulating an Ethernet Synchronization Messaging Channel “ESMC” message that comprises at least one Type Length Value “TLV” field different from the Quality Level field, known as “QL-TLV”.

The present invention also pertains to a Synchronous Ethernet-Synchronous Optical Networking/Synchronous Digital Hierarchy “SyncE-SONET/SDH” hybrid node comprising
reception means capable of receiving at least one Ethernet Synchronization Messaging Channel “ESMC” message comprising at least one Type Length Value “TLV” field that is different from the Quality Level “QL-TLV” field encapsulated to be transmitted through a Synchronous Optical Networking/Synchronous Digital Hierarchy “SDH/SONET” domain, and
means for unencapsulating said message and means for reading Type Length Value “TLV” fields.

The present invention also pertains to a Synchronous Optical Networking/Synchronous Digital Hierarchy “SONET/SDH” node comprising
means for receiving synchronization signals intended for a Synchronous Ethernet “SyncE” domain,
means for selecting said synchronizations signals based on a priority list provided by a synchronization management system or based on quality level “QL” values contained in the SONET/SDH frame in the event that the primary synchronization signal defined both by the priority list and the quality levels “QL” of the available synchronization signals is degraded, and
means for transmitting an alarm message to said synchronization management system indicating the information that identifies the physical port associated with the new primary synchronization signal transmitted to the Synchronous Ethernet “SyncE” domain in the event that the initial primary synchronization signal fails.

The present invention also pertains to a synchronization management system comprising
means for creating and configuring a priority list of synchronization signals intended to be distributed from a first Synchronous Ethernet “SyncE” domain to a second Synchronous Ethernet “SyncE” domain through a third Synchronous Optical Networking/Synchronous Digital Hierarchy “SONET/SDH” domain,
means for transmitting said list to the nodes of said Synchronous Optical Networking/Synchronous Digital Hierarchy “SONET/SDH” domain,
means for receiving an alarm message issued by a node of the SONET/SDH domain indicating the identity of the new port associated with the new selected primary synchronization signal,
means for performing the correlation between the identity of the new port associated with the new primary synchronization signal, and the tunnel encapsulating the Ethernet Synchronization Messaging Channel “ESMC” messages associated with the new primary signal,
means for transmitting, to the destination Synchronous Ethernet-Synchronous Optical Networking/Synchronous Digital Hierarchy “SyncE-SONET/SDH” hybrid node, located at the junction of the second and third domains, a message indicating the identity of the tunnel encapsulating the Ethernet Synchronization Messaging Channel “ESMC” messages to be considered.

Other characteristics and benefits of the invention will become apparent from the following description, given with reference to the attached drawings, which by way of a non-limiting example depict one possible embodiment.

In these drawings:

FIG. 1 depicts a schematic of three types of synchronization chains, the first one (a) comprising only SDH/SONET nodes, the second one (b) comprising SDH/SONET nodes and Synchronous Ethernet (SyncE) nodes, and the third one (c) comprising SDH/SONET nodes and SDH/SONET-SyncE hybrid nodes;

FIG. 2 depicts a diagram of a synchronization configuration in which two SyncE domains are interconnected by a SDH/SONET domain;

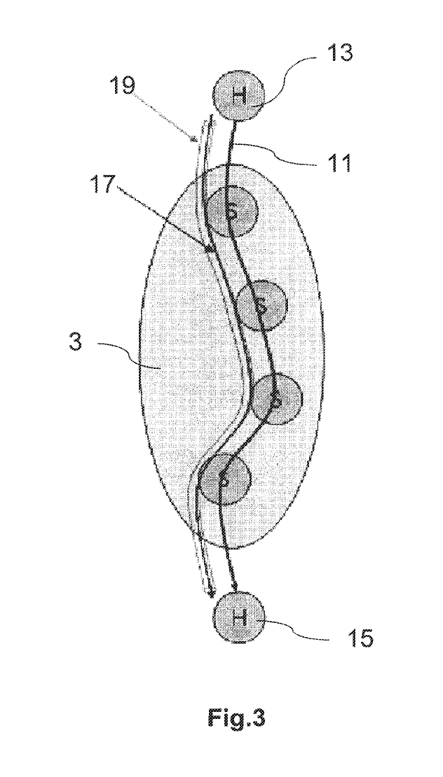

FIG. 3 depicts the creation of a network tunnel between two border hybrid nodes (of the respective SyncE domains) through a SDH/SONET domain;

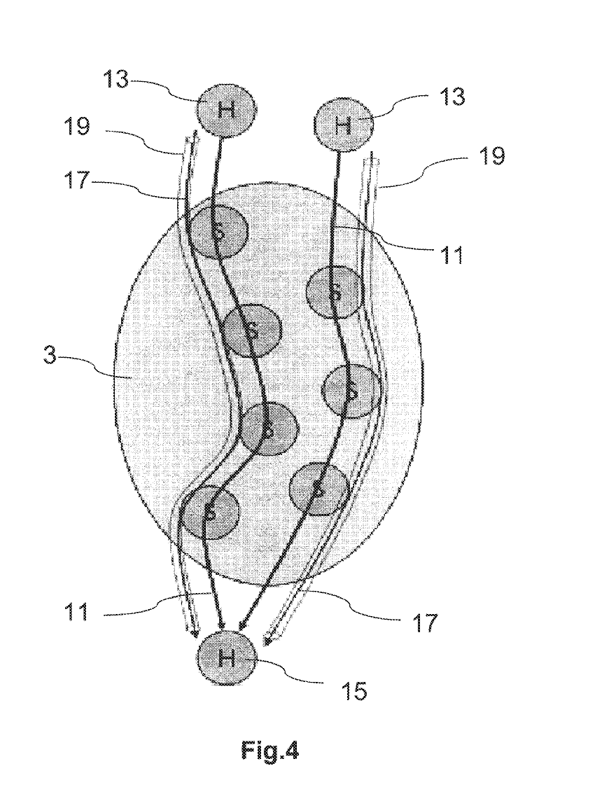

FIG. 4 depicts the creation of two tunnels connecting two SyncE domains through a SDH/SONET domain and having a common destination border hybrid node;

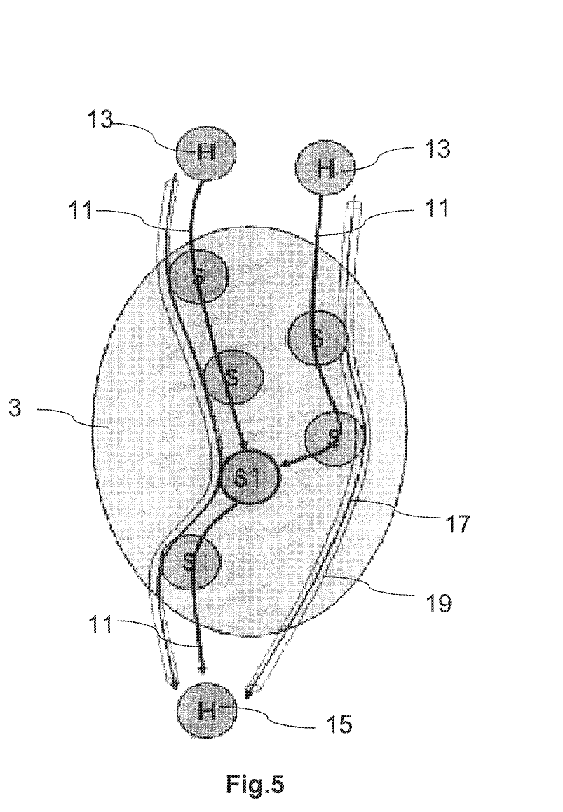

FIG. 5 depicts the creation of two tunnels connecting two SyncE domains through a SDH/SONET domain having a common destination border hybrid node and also having a common path segment within the SDH/SONET domain;

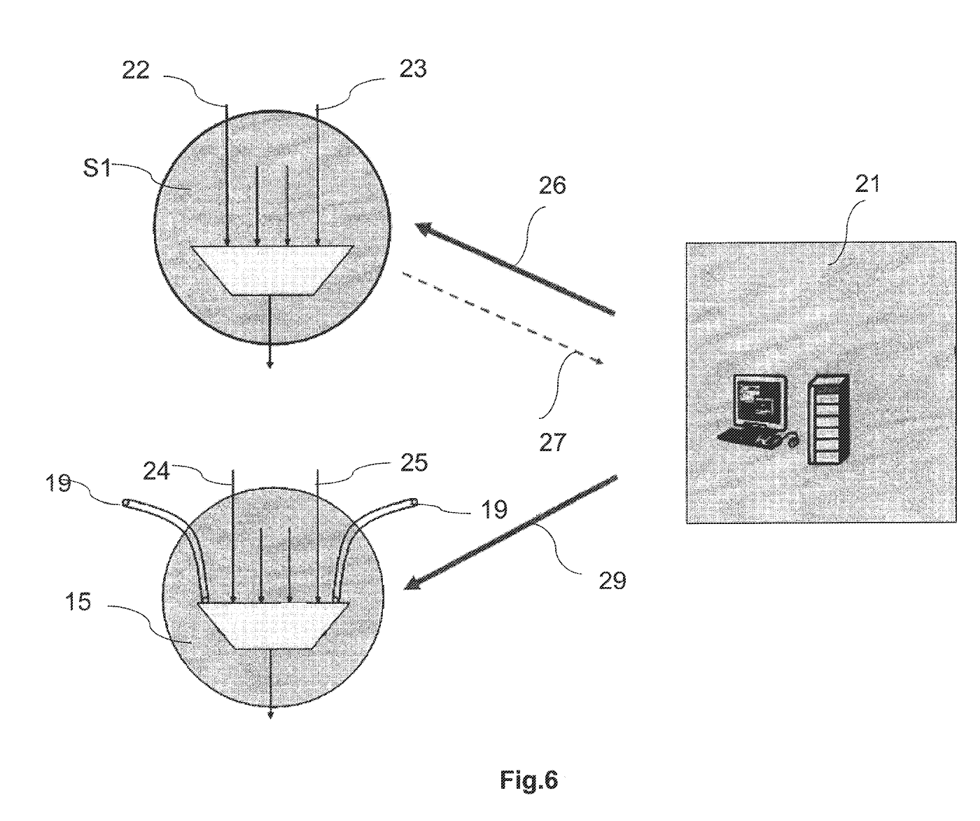

FIG. 6 depicts the messages exchanged between the synchronization management system and the node S1 located within the SONET/SDH domain on one hand, and between the synchronization management system and the destination hybrid node located at the interface of the SONET/SDH domain and the second SyncE domain on the other hand;

In the following description, generally:

The term “ESMC” stands for Ethernet Synchronization Messaging Channel; The term “SONET” stands for Synchronous Optical Networking;

The term “SDH” stands for Synchronous Digital Hierarchy;

The term “TLV” stands for Type Length Value;

The term “QL” Quality Level;

The term “SyncE” stands for Synchronous Ethernet;

The term “encapsulation” refers to encapsulation with respect to packets, in which the packet is enclosed within a protocol structure (comprising a header, checksum, etc.) so as to allow it to be transmitted into another domain managed by a different protocol; the term “unencapsulation” refers to the reverse operation, the outcome of which is the initial packet.

The embodiments of the present invention refer to the transmission of ESMC messages within a tunnel connecting two SyncE domains through a SDH/SONET domain. As depicted in FIG. 3, synchronization may be distributed by physical synchronization signals 11 of a source border hybrid node 13 belonging to a first SyncE domain to a destination border hybrid node 15 belonging to a second SyncE domain. This distribution is done end to end within the physical layer through the SONET/SDH domain. Meanwhile, the ESMC messages 17 are encapsulated within the source border hybrid node 13, transmitted through the SONET/SDH domain 3 by means of a network tunnel 19 associated with the ESMC message, then unencapsulated within the destination border hybrid node 15. Because of the encapsulation, the ESMC messages 17 traverse the SDH/SONET domain transparently, which makes it possible to avoid filtering the additional TLV fields 7 at the SDH/SONET-SyncE interfaces.

Furthermore, it should be noted that because the network tunnel 19 associated with the ESMC messages transparently traverses the SDH/SONET nodes S, the path taken by that tunnel is not connected to the path taken by the synchronization signals 11. Nonetheless, it is recommended that the paths taken be the same, whenever possible, in order to allow more effective protection in the event that the synchronization path is reconfigured owing, for example, to a degradation in the primary signal.

The information on the quality level (QL) is normally transmitted via the SONET/SDH header, but it may additionally be encapsulated with the other TLV structures and transmitted on the packet level through the tunnel associated with the previously described ESMC message. If that happens, the QL value extracted from the physical level of the SDH/SONET domain may be compared to the encapsulated QL value, and if there is any inconsistency between the two QL values, the encapsulated value is then ignored by the destination border hybrid node 15 and an alarm is sent to the synchronization management system, in order to report such an inconsistency.

The setting up of tunnels 19 as described by FIG. 3 may lead to the situation described in FIG. 4 wherein two different tunnels, having different paths, derived from two different source border hybrid nodes 13 and corresponding to two different synchronization distribution paths have a common destination border hybrid node 15. In such a context, one of the two source border hybrid nodes 13 corresponds to the primary frequency source, and the other corresponds to the secondary frequency source. If so, it is necessary to be able to distinguish the ESMC messages 17 that come from the two tunnels so as to tell which ESMC message 17 corresponds to which synchronization signal 11, and consequently which synchronization source.

This way, according to one embodiment of the present invention, one of the additional TLV fields 9 is a field that makes it possible to tell apart two ESMC tunnels 19. This field may, for example, be a “source ID TLV” TLV field comprising an identification of the source border hybrid node of the ESMC tunnel 13 or a “tunnel ID TLV” field comprising an identification of the tunnel 19 or a “trace route” field comprising an identification of all of the nodes crossed by the ESMC message 17, or a combination of those three fields. For the “source ID TLV” and “tunnel ID TLV” fields, said fields are deleted from the destination border hybrid node 15.

Another configuration presented in FIG. 5 corresponds to two synchronization distribution paths, coming from two different synchronization sources, having one node, or even a common segment within the SDH/SONET domain 3. Thus, when a node of the SDH/SONET domain receives (physical) synchronization signals coming from two different source border hybrid nodes 13, the SDH/SONET node, which receives the two synchronization distributions, denoted S1, performs a selection between the two distributions, and transmits the selected signal to the destination border hybrid node 15. This selection is generally performed by following the priority rules sent by the synchronization management system, for example, by sending a priority list. This is because, in the SDH/SONET domain, synchronization is traditionally controlled by the synchronization management system.

However, in the event of degradation (of the QL level) or if the primary synchronization signal fails, the re-selection of a new synchronization source is carried out locally within the node S1: by comparing the “QL-TLV” quality level values contained within the SONET/SDH frame, for example. But in such a case, the destination border hybrid node 15 cannot know the onset or result of that selection, which would allow it to associate the physical synchronization path with the relative ESMC information transported on the packet level, through a network tunnel

In order to announce to the destination border hybrid node 15, the identity of the primary synchronization signal's source that is transmitted to it in the event of a re-selection, according to one embodiment of the present invention, a re-selection message (e.g. an alarm) is sent by the node S1 to the synchronization management system in order to inform that system of the physical port connected to the new primary synchronization signal 11, which will be transmitted to the destination border hybrid node 15. The synchronization management system is thereafter responsible for making the connection between the information on the port of the new primary signal thereby selected within the node S1 and the identity of the source border hybrid node associated with the new synchronization signal thereby selected by S1; this can be done, for example, by cooperating with the SONET/SDH network management system.

In general, the selection of synchronization sources within the node S1 is carried out automatically, within the software and not within the hardware. Consequently, it is fairly easy to update the software in order to add instructions such as sending an alarm to the synchronization management system.

FIG. 6 depicts the different signals exchanged with the synchronization management system 21.

When it starts up, the synchronization management system 21 sends the node S1 a configuration message 26 comprising, for example, a priority list in order to locally control the synchronization signal selection process from among the synchronization signals received at the physical ports 22 and 23. The primary synchronization signal serves to lock the local clock of the equipment S1. The present scenario assumes that the primary synchronization signal initially selected by the node S1 is provided by the port 22.

If there is degradation in the quality level or that primary signal fails, the node S1 re-selects the primary signal based on the quality level of the received signals and on the priority list. In FIG. 6, the new primary signal is provided by the port 23. An alarm message 27, comprising an identification of the physical port 23, is then sent to the synchronization management system 21. Based on the identification of the selected physical port 23, the synchronization management system 21 finds (owing to mapping with established connections) the identification of the associated source border hybrid node 13, also known as the source (the source ID). A message 29, containing the source border hybrid node's identification (the source ID) 13, is then transmitted to the destination border hybrid node 15. That node may then select, from among the ESMC tunnels 19 to which it is connected, the ESMC tunnel 19 corresponding to the source thereby indicated.

This method therefore enables the destination border hybrid node to associate the associated tunnel with the ESMC message to the source of the selected primary signal.

It should also be noted that the embodiments presented above for two physical synchronization distribution paths may be extended to more than two distribution paths from different (synchronization) sources, and the presented selection modes may be applied to any number of synchronization frequency distribution paths.

Thus, the embodiments of the present invention make it possible to transmit ESMC messages 17 comprising additional TLV fields 7 between two SyncE domains 1 interconnected by a SDH/SONET domain 3 while avoiding the filtering of the information carried by those additional fields 7 at the interface between the domains and allowing the destination border hybrid node 15 to associate the ESMC messages 17 received with the received primary synchronization signal 11 and therefore to use those messages consistently with the primary synchronization physical signal.

1. A method for transmitting an Ethernet Synchronization Messaging Channel “ESMC” message between a first and a second Synchronous Ethernet “SyncE” domain, said first and second domains being interconnected by a third, Synchronous Optical Networking or Synchronous Digital Hierarchy “SONET/SDH” domain, comprising the steps of:
encapsulating at least one part of said ESMC message when entering said third domain; and
unencapsulating said at least one part of said ESMC message when exiting said third domain, so as to create a network tunnel through the third SONET/SDH domain.

2. A method for transmitting an Ethernet Synchronization Messaging Channel “ESMC” message according to claim 1 wherein said message comprises at least one Type Length Value “TLV” field different from the Quality Level “QL-TLV” field.

3. A method for transmitting an Ethernet Synchronization Messaging Channel “ESMC” message according to claim 1, wherein the steps of encapsulating and unencapsulating the messages are done within the Synchronous Ethernet-Synchronous Optical Networking/Synchronous Digital Hierarchy “SyncE-SONET/SDH” hybrid nodes located at the interface of the various domains.

4. A method for transmitting an Ethernet Synchronization Messaging Channel “ESMC” message according to claim 3 wherein a SyncE-SONET/SDH hybrid node receives
firstly, at least two distinct synchronization signals that have taken different routes and that come from different source border hybrid nodes, and,
secondly, at least two different ESMC messages corresponding to said at least two synchronization signals, and coming from different tunnels,
wherein said at least two messages comprising an additional Type Length Value “TLV” field that makes it possible to tell different ESMC messages apart.

5. A method for transmitting an Ethernet Synchronization Messaging Channel “ESMC” message according to claim 3 wherein a SONET/SDH node receives at least two different synchronization signals that took different routes and come from different source border hybrid nodes, further comprising the steps of:
selecting a primary synchronization signal to be distributed based on a priority list provided by a synchronization management system,
and if the primary synchronization signal degrades and the primary synchronization signal is reselected,
transmitting a message, comprising an identification of the new selected primary synchronization signal to the synchronization management system;
and transmitting, to the destination SyncE-SONET/SDH hybrid node, an identification of the synchronization source corresponding to the selected synchronization signal in order to allow the destination border hybrid node to consider the tunnel encapsulating the ESMC message associated with the selected primary synchronization signal.

6. A method for transmitting an Ethernet Synchronization Messaging Channel “ESMC” message according to claim 2 wherein the, at least one, additional Type Length Value “TLV” field indicates the stability level of the frequency provided by the frequency source.

7. A method for transmitting an Ethernet Synchronization Messaging Channel “ESMC” message according to claim 2 wherein the, at least one, additional Type Length Value “TLV” field indicates the number of nodes traversed by said message since its source node.

8. A method for transmitting an Ethernet Synchronization Messaging Channel “ESMC” message according to claim 2 wherein the, at least one, additional Type Length Value “TLV” field comprises an identification of the nodes traversed by said message.

9. A method for transmitting an Ethernet Synchronization Messaging Channel “ESMC” according to claim 1 wherein a synchronization signal is transmitted with the ESMC and the tunnel associated with the ESMC of the SONET/SDH domain follows the same route as the synchronization signal.

10. A method for transmitting an Ethernet Synchronization Messaging Channel “ESMC” according to claim 1 wherein a synchronization signal is transmitted with the ESMC and the tunnel associated with the ESMC of the SONET/SDH domain follows a different route than the synchronization signal.

11. A Synchronous Ethernet-Synchronous Optical Networking/Synchronous Digital Hierarchy “SyncE-SONET/SDH” hybrid node comprising means for encapsulating an Ethernet Synchronization Messaging Channel “ESMC” message that comprises at least one Type Length Value “TLV” field different from the Quality Level field, known as “QL-TLV”.

12. A Synchronous Ethernet-Synchronous Optical Networking/Synchronous Digital Hierarchy “SyncE-SDH/SONET” hybrid node comprising
reception means capable of receiving at least one Ethernet Synchronization Messaging Channel “ESMC” message comprising at least one Type Length Value “TLV” field that is different from the Quality Level “QL-TLV” field encapsulated to be transmitted through a Synchronous Optical Networking/Synchronous Digital Hierarchy “SONET/SDH” domain; and
means for unencapsulating said message and means for reading Type Length Value “TLV” fields.

13. A Synchronous Optical Networking/Synchronous Digital Hierarchy “SDH/SONET” node comprising
means for receiving synchronization signals intended for a Synchronous Ethernet “SyncE” domain;
means for selecting said synchronizations signals based on a priority list provided by a synchronization management system or based on quality level “QL” values contained in the SONET/SDH frame in the event that the primary synchronization signal defined both by the priority list and the quality levels “QLs” of the available synchronization signals is degraded; and
means for transmitting an alarm message to said synchronization management system indicating the information that identifies the physical port associated with the new primary synchronization signal transmitted to the Synchronous Ethernet “SyncE” domain in the event that the initial primary synchronization signal fails.

14. A synchronization management system comprising
means for creating and configuring a priority list of synchronization signals intended to be distributed from a first Synchronous Ethernet “SyncE” domain to a second Synchronous Ethernet “SyncE” domain through a third Synchronous Optical Networking/Synchronous Digital Hierarchy “SONET/SDH” domain;
means for transmitting said list to the nodes of said Synchronous Optical Networking/Synchronous Digital Hierarchy “SONET/SDH” domain;
means for receiving an alarm message issued by a node of the SONET/SDH domain indicating the identity of the new port associated with the new selected primary synchronization signal;
means for performing the correlation between the identity of the new port associated with the new primary synchronization signal, and the tunnel encapsulating the Ethernet Synchronization Messaging Channel “ESMC” messages associated with the new primary signal; and
means for transmitting, to the destination Synchronous Ethernet-Synchronous Optical Networking/Synchronous Digital Hierarchy “SyncE-SONET/SDH” hybrid node, located at the interface of the second and third domains, a message indicating the identity of the tunnel encapsulating the ESMC messages to be considered.
